(19) United States
(12) Patent Application Publication
(10) Pub. No.: US 2005/0195966 A1
(43) Pub. Date: Sep. 8, 2005

(54) Method and apparatus for optimizing the results produced by a prediction model

(75) Inventors: Michel Adar, Palo Alto, CA (US); Earl Stahl, Hillsborough, CA (US); Nicolas M. Bonnet, Palo Alto, CA (US)

Correspondence Address: BEYER WEAVER & THOMAS LLP, P.O. BOX 70250, OAKLAND, CA, 94612-0250, US

(73) Assignee: Sigma Dynamics, Inc.

(21) Appl. No.: 10/980,440

(22) Filed: Nov. 2, 2004

Related U.S. Application Data
(60) Provisional application No. 60/550,887, filed on Mar. 3, 2004.

(51) Int. Cl. H04M 3/00; H04M 5/00

(52) U.S. Cl. 379/266.08

(57) ABSTRACT

Disclosed are methods and apparatus for optimizing results produced by a predictive model in order to determine which action to perform out of a plurality of actions. In an operation (a), a plurality of goal metrics are provided for a plurality of possible actions based on a plurality of input conditions. One or more of the goal metrics are produced by one or more predictive models. In an operation (b), the plurality of goal metrics are normalized. In an operation (c), for each possible action a total of each of the normalized goal metrics multiplied by a corresponding predetermined weight is determined. In an operation (d), the totals determined for the plurality of possible actions are compared to thereby determine a highest total. In an operation (e), an action selected from the plurality of possible actions is performed, where the selected action has the highest total. In one implementation, operations (a) through (e) are repeated for a plurality of sets of input conditions, and normalizing the goal metrics for a current set of input conditions is accomplished by assigning a point value for each goal metric of each action, wherein the point value corresponds to the percentage of previously determined corresponding goal metric values that are less valuable than the current goal metric value

### CROSS REFERENCE TO RELATED PATENT APPLICATION

This application claims priority of U.S. Provisional Patent Application No. 60/550,887 (Attorney Docket No. SIGMP006P), filed Mar. 3, 2004 by Michel Adar et al., which application is incorporated herein by reference in its entirety for all purposes. This application is related to concurrently filed U.S. patent application Ser. No. ______ (Attorney Docket No. SIGMP004), entitled “Method and Apparatus for Automatically and Continuously Pruning Prediction Models in Real Time Based on Data Mining” by Sergey A. Prigogin et al., which application is incorporated herein by reference in its entirety for all purposes.

### BACKGROUND OF THE INVENTION

The present invention relates to the general technical area of modeling interactions between various entities, such as a customer and a telephone call center. More specifically, it relates to mechanisms for using the results produced from such modeling to determine which action to take with respect to a particular entity, such as a customer having a particular profile.

Consumers of products and services are increasingly using automated interaction channels such as Internet web sites and telephone call centers. Such automated sales channels typically provide an automated process which attempts to match potential customers with desirable products and/or services. In the case of web sites, the interaction channel may be fully automated. In the case of call centers, human customer-service agents are often used. One goal of the companies selling the products and services is to maximize total enterprise profitability and, therefore, companies will often invest heavily in creating computerized models in an attempt to maximize their revenue and minimize their expenses for both of these types of sales channels.

Prediction modeling is generally used to predict the outcome of numerous decisions which could be implemented. In a most simplistic example, a prediction model may predict the likelihood (or probability) of a particular result or outcome occurring if a particular action was performed (e.g., a particular decision is carried out) under one or more specific conditions. In a more complex scenario, a prediction model may predict the probabilities of a plurality of outcomes for a plurality of actions being performed under various conditions.

In a specific application, prediction modeling may be used to decide which specific interactions are to be taken by a company's service or product sales center (e.g., website or telephone call center) when a customer is interacting with such center. The prediction modeling helps the company select an interaction that is likely to result in a desirable goal being met. Automated sales centers, for example, typically provide an automated process which attempts to match potential or current customers with desirable products and/or services. In the case of websites, the sales center may be fully automated. In the case of call centers, human customer-service agents in conjunction with automated interactive voice recognition (IVR) processes or agents are often used.

For example, a customer may go to a particular website or call center of a company which specializes in selling automobiles. From the company's perspective, the company may have a goal of maximizing automobile revenue to each customer who interacts with its website or telephone call center. When a customer initially accesses the website or call center, it may be possible to select any number of sales promotions to present to the customer (e.g., via a web page or communicated by a human sales agent). Prediction models may be used to determine which sale promotion to present to a given customer to more likely achieve the goal of maximizing sales revenue. For instance, it may be determined that a particular type of customer is highly likely to buy a particular type of automobile if presented with a sales presentation for such item.

Although conventional predictive modeling has worked well in determining which actions to perform to achieve a single goal, such as maximizing profitability, current modeling techniques fail to provide a way to evaluate and assess a wide variety of goals. For example, a company may wish to use predictive modeling to assess the sometimes competing goals of maximizing profits while maximizing levels of customer satisfaction.

In view of the above, there is a need for improved mechanisms for affectively using prediction models to achieve a wide variety of goals. Additionally, it would be desirable to balance or weigh the relative values of such goals with respect to specific actions or decisions when determining which action to perform based on the results from a prediction model.

### SUMMARY OF THE INVENTION

In one embodiment, a method of optimizing results produced by a predictive model in order to determine which action to perform out of a plurality of actions is disclosed. In operation (a)a plurality of goal metrics are provided for a plurality of possible actions based on a plurality of input conditions. One or more of the goal metrics are produced by one or more predictive models. In an operation (b), the plurality of goal metrics are normalized. In an operation (c), for each possible action a total of each of the normalized goal metrics multiplied by a corresponding predetermined weight is determined. In an operation (d), the totals determined for the plurality of possible actions are compared to thereby determine a highest total. In an operation (e), an action selected from the plurality of possible actions is performed, where the selected action has the highest total.

In a specific embodiment, operations (a) through (e) are repeated for a plurality of sets of input conditions. The task of normalizing the goal metrics for a current set of input conditions includes assigning a point value for each goal metric of each action, wherein the point value corresponds to the percentage of previously determined corresponding goal metric values that are less valuable than the current goal metric value. In a further aspect, the sets of input conditions corresponding to a plurality of customer profiles of a plurality of customers and the possible actions are a plurality of offers which were presented to the customers. In one example, at least two of the goal metrics have different units. In another example, at least two of the goal metrics correspond to competing goals.

In a particular aspect, the plurality of possible actions are a plurality of offers which can be presented to a potential customer. In a further aspect, the offers can be presented in the form of one or more web pages to a customer who is currently accessing a web server. In yet another aspect, the offers can be presented in the form of an automated Interactive Voice Recognition (IVR) option to a customer who is currently accessing a telephone call center. In another implementation, the goal metrics include a minimum cost metric, an increase in revenue metric, an increase in customer satisfaction metric, and a likelihood of acceptance of offer metric. In a further aspect, the goal metrics further include a reduction of customer returns metric, an increase in awareness metric, and a compliance metric for measuring the compliance level with a marketing person's objective.

In another embodiment, the invention pertains to a computer system operable to optimize results produced by a predictive model in order to determine which action to perform out of a plurality of actions. The computer system includes one or more processors and one or more memory. At least one of the memory and processors are adapted to provide at least some of the above described method operations. In yet a further embodiment, the invention pertains to a computer program product for optimizing results produced by a predictive model in order to determine which action to perform out of a plurality of actions. The computer program product has at least one computer readable medium and computer program instructions stored within at least one of the computer readable product configured to perform at least some of the above described method operations.

These and other features and advantages of the present invention will be presented in more detail in the following specification of the invention and the accompanying figures that illustrate by way of example the principles of the invention.

### BRIEF DESCRIPTION OF THE DRAWINGS

FIG. 1 is a diagrammatic representation of an exemplary first sales channel for which techniques of the present invention may be applied.

FIG. 2 is a diagrammatic representation of an exemplary second sales channel for which techniques of the present invention may be applied.

FIG. 3 is a diagram illustrating an exemplary distributed learning system in which techniques of the present invention may be implemented.

FIG. 4 is a flowchart illustrating a procedure for implementing a decision using an updated prediction model in accordance with one embodiment of the present invention.

FIG. 5 is a table illustrating an optimization technique in accordance with one embodiment of the present invention.

FIG. 6 is a bar graph illustrating a normalization techniques for a key performance indicator (KPI) or goal in accordance with a specific implementation of the present invention.

FIG. 7 is a block diagram of a general purpose computer system suitable for carrying out the processing in accordance with one embodiment of the present invention.

### DETAILED DESCRIPTION OF SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

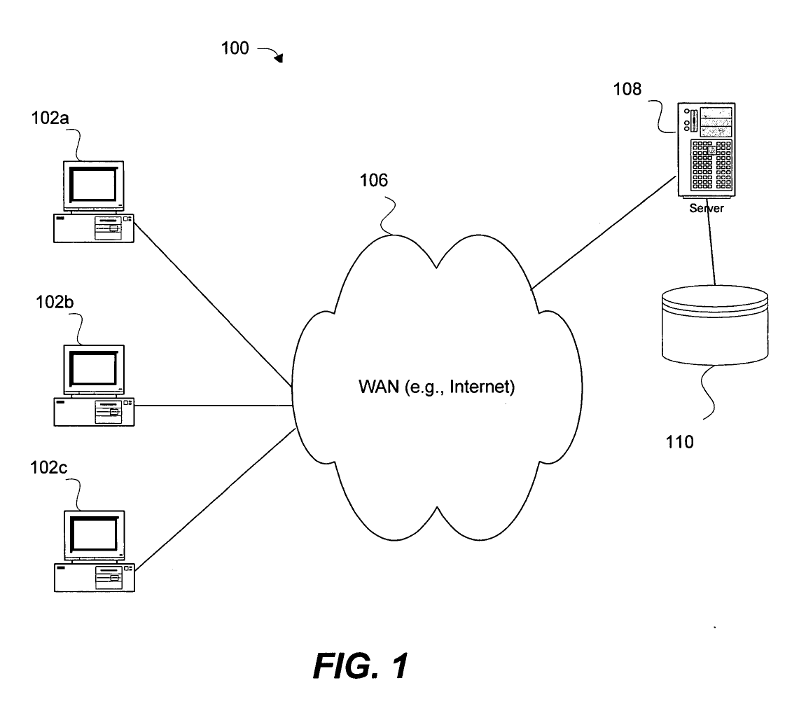

FIG. 1 is a diagrammatic representation of an exemplary first sales channel 100 for which techniques of the present invention may be applied. As shown, the sales channel 100 includes a plurality of hosts 102 and a web server 108 which are both coupled to a wide area network (WAN) 106, e.g., the Internet. Any suitable type of entity or user (such as a person or an automated process) may access the web server 108 via host device 102. The server 108 may also be in communication with one or more database 110. The web server 108 may be configured to provide various products and services to various users. For example, the web server 108 may include an on-line store for customers to purchase various products and an on-line service center for providing customers with FAQ's or trouble shooting help regarding their purchased products.

In a sales environment, potential customers on computers 102 or the like access the web server 108 via the Internet 106 or the like. Their experience at the website hosted by web server 108 is dictated or influenced by one or more prediction models running, for example, on the web server 108 and obtained from database 110, for example. The prediction model is preferably self-learning, at least based in part, on the interactions of the potential customers and the website. Information regarding the customers and website interactions is preferably stored in database 110. It should be noted that the computers, network, servers, databases, machines, etc. that are illustrated in FIG. 1 are logical in nature, and some are all of their functionalities can be performed on one or more physical machines, systems, media, etc.

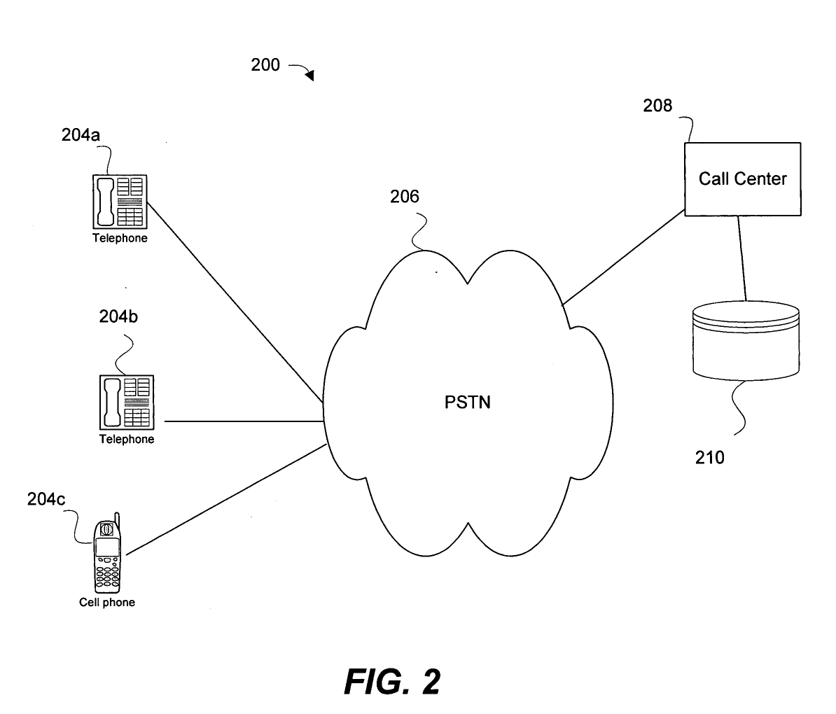

FIG. 2 illustrates an exemplary second sales channel 24 which has certain analogies with the exemplary first sales channel 100. In second sales channel 200, users may access call center 208 though individual telephones 204 or the like via a telephone system 206 (public switched telephone network or PSTN) or the like. The call center 208 may maintain a database 210 for essentially the same purposes that the web server 108 of FIG. 1 maintains the database 110 in the first sales channel 100. Users may communicate and interact with agents (human or automated) or an IVR system at the call center 108. Again, the telephones, telephone system, call center, and database, etc., of FIG. 2 are illustrated in a functional form and their actual physical manifestations may differ from implementation to implementation.

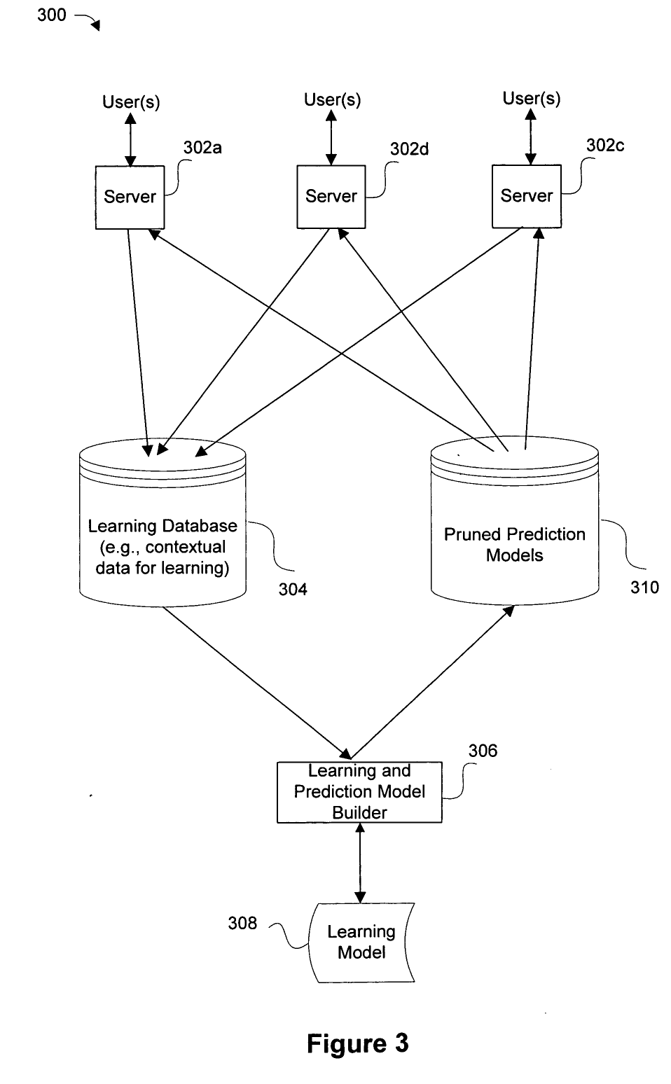

FIG. 3 is a diagram illustrating an exemplary distributed learning system 300 in which techniques of the present invention may be implemented. Of course, the present invention may be implemented in any suitable system that implements predictive modeling. As shown in FIG. 3, system 300 includes one or more interactive servers 302, a learning database 304, a prediction model repository 310, a learning and prediction model builder server 306, and a learning model 308. The learning system preferably includes a plurality of distributed interactive servers 302 although a single interactive server is also contemplated.

Interactive servers 302 execute one or more prediction models to determine specific transaction paths to follow, such as which web page or automated interactive voice message to present to a particular customer. A single prediction model may be used to predict the probability of a particular outcome or any number of outcomes based on a specific number of input attributes or contextual data and their corresponding values. Contextual data is in the form of a finite set of input factors which are deemed to have an effect on whether a particular goal or outcome is met when particular decisions or events occur. Input attributes may include attributes of a contacting entity (such as a potential or current customer), attributes of an answering entity (such as sales or service agent), time information regarding when specific events occur, etc. Alternatively, a plurality of prediction models may be used to determine the probability of a plurality of outcomes. Each single prediction model may be used to predict each single outcome probability. For example, a first prediction model may be used to determine the probabilities of achieving a first outcome when a particular decision (or action plan) is implemented with respect to various customer's with specific characteristics or profiles, and a second prediction model is used to determine the probabilities of achieving a second outcome when a particular decision (or action plan) is implemented with respect to various customer's with specific characteristics or profiles. In sum, any number of prediction models may be used to predict any number of outcomes under any number of different input attribute values.

The prediction models may be retrieved from (or sent by) one or more prediction models database 310. The interactive servers 302 also may be configured to collect contextual data regarding the input attributes used in the prediction model, as well as the results of the selected interaction or decision path. This contextual data is collected from one or more interactive servers 302 and stored in learning database 304.

Learning and prediction model builder 306 is generally configured to use the data from learning database 304 to update (the terms update, build, create, or modify are used interchangeably herein) one or more prediction models that are then sent to prediction model database 310. Additionally, model builder 306 may also prune one or more learning models 308 to generate one or more pruned prediction models, which are stored in prediction model database 310. A pruned prediction model is generally a learning model whose input attributes have been trimmed down to a subset of attributes (or attribute values) so as to be more efficient. That is, the pruned prediction model will typically have less input attributes to affect its results than the learning model from which it has been pruned. Pruned prediction models are used by the interactive servers 302 to formulate decisions or select particular interaction paths. Of course, pruning is not necessary for practicing the techniques of the present invention and the learning or prediction model may be used without trimming the input attributes. The builder 306 may also be configured to update the one or more learning models if necessary.

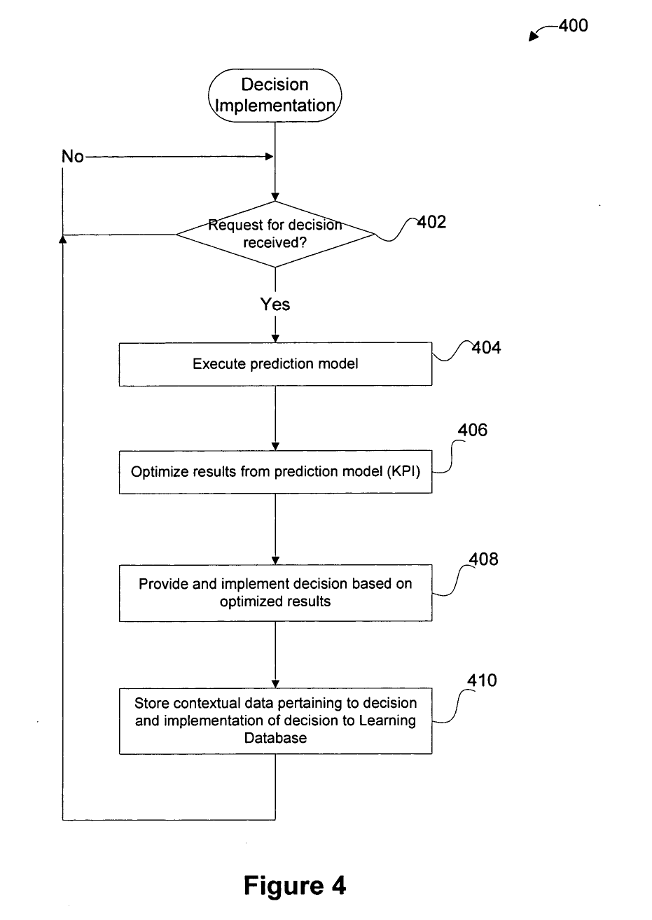

FIG. 4 is a flowchart illustrating a procedure 400 for implementing a decision using a prediction model in accordance with one embodiment of the present invention. The following procedure represents merely one example of a flow in which the techniques of the present invention may be implemented. In the example of FIG. 3, this procedure 400 may be executed on any one of servers 302, for example. Initially, a request for a decision may be received at operation 402. For instance, a customer may access a particular website of a company or call a company's service telephone number. The automatic process that is automatically interacting with the customer may be making a request for a particular decision regarding which web page, automated voice interaction, or particular live sales agent is to be presented to the particular customer. The request may be received at any time during the customer interaction process, e.g., at any web page in a series of sequentially presented web pages or at the beginning or at any intermediary point of an IVR telephone call. The request may also be made by a person, rather than an automatic process. For example, a sales representative may be making requests via a graphical user interface while interacting with a customer through some form of computer data exchange, such as a chat session, or a via a telephone interaction.

One or more prediction models are then executed based on the contextual data or input attributes associated with the particular decision request in operation 404. In a sales type application, the prediction model may produce a probability value for each potential offer being accepted by the customer if such offer is presented to the customer.

In embodiments of the present invention, the prediction model also assigns a value for each of a plurality of key performance indicators (“KPI's”) or goals for each of the different decision choices (e.g., presented offers). In the sales offer example, the prediction model may output a value for a number of factors (or KPI's) that each correspond to how well a particular performance goal is being met when each offer is accepted. For instance, the performance goals may include both minimizing cost and maximizing revenue, as well as the probability of the offer being accepted if presented to the customer. In this example, the prediction model may determine that if a particular offer is accepted it will result in $50 cost for the “minimizing cost” KPI, a revenue increase of $90 for the “maximizing revenue” KPI, and a 27% value for the probability of acceptance KPI. A second offer may result in different KPI values if the second offer is accepted.

Several suitable embodiments for generating a prediction model are further described concurrently filed U.S. patent application Ser. No. ______ (Attorney Docket No. SIGMP004), entitled “Method and Apparatus for Automatically and Continuously Pruning Prediction Models in Real Time Based on Data Mining” by Sergey A. Prigogin et al., which application is incorporated herein by reference in its entirety for all purposes.

The KPI values for each decision (e.g., a particular offer is presented) may then be compared in an optimization operation 406. For example, it is determined which decision to implement based on the relative importance of the various KPI's of the decisions. Several optimization embodiments are further described below.

The selected decision is then provided and implemented based on the optimized results in operation 408. For example, the selected offer is presented to the customer. The contextual data (e.g., input attributes and results of the decision) are then stored, for example, in the learning database 304 in operation 410. Any suitable input attributes that are likely to affect the outcome of the prediction model are retained. In the sales example, a customer's demographics, sales history, and specifics of their interactions with the sales center may be retained as contextual data. After the contextual data is stored, the decision implementation procedure 400 may then be repeated for the next decision request.

In general, the present invention includes techniques for optimizing the results produced by one or more predictive models based on a plurality of current input conditions (or input attributes). In a sales application, the predictive model determines a plurality of metrics for a number of different desirable goals for each of an offer that may be accepted by a particular customer. The predictive model determines metrics for a plurality of offers for the particular customer.

The optimization techniques may be implemented with the results of any suitable predictive modeling and are not limited to the modeling techniques described herein. Additionally, the optimization techniques do not require a self learning type of modeling system as described herein. That is, the predictive models may be updated off line by data mining experts and not updated automatically as described herein.

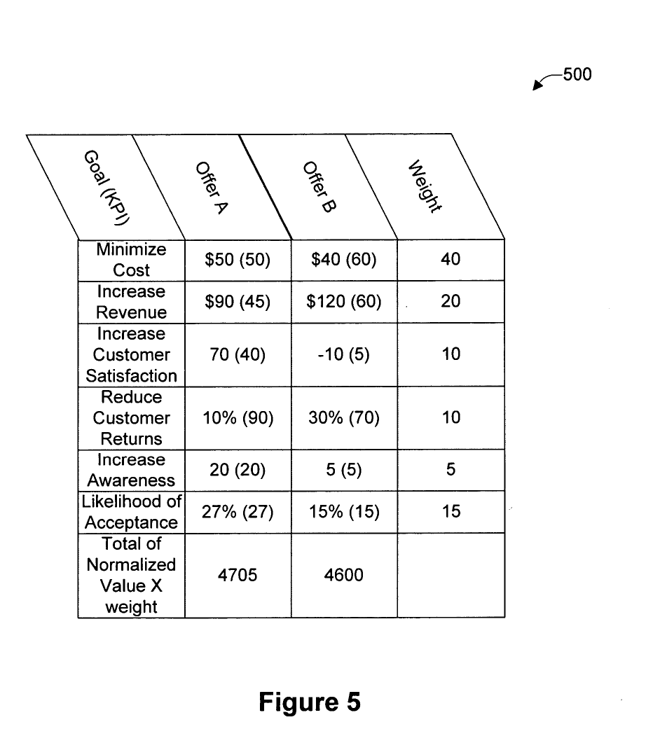

FIG. 5 is a table 500 that will be used to illustrate an optimization technique in accordance with one embodiment of the present invention. Initially, for a plurality of possible actions, a plurality of goal metrics or key performance indicators (KPI's) are provided based on a plurality of current input conditions. These metrics may be provided in any suitable manner, such as provided by one or more predictive models, predetermined or provided by the interacting entity (e.g., customer). In this example, the actions include (i) an Offer A being presented to the particular customer and (ii) an Offer B being presented to the particular customer. The table 500 of FIG. 5 includes a column identifying the different goals for which metrics are provided, and the 2^{nd} and 3^{rd} columns list corresponding specific goal values as determined for Offer A and Offer B, respectively.

In this example, the goal metrics include (i) a Minimum Cost metric, (ii) an Increase in Revenue metric, (iii) an Increase in Customer Satisfaction metric, (iv) a Reduction of Customer Returns metric, (v) an Increase in Awareness metric, and (vi) a Likelihood of Acceptance of Offer metric. The predictive model may generate any suitable combination of these goal metrics for each action (or offer). Other goal metrics may include (i) a compliance metric for measuring the compliance level with a marketing person's objective, (ii) a service level agreement metric measuring the compliance to an agreed upon service metric (for example, wait time in the queue), (iii) a measure of the number of products owned by the customer (with the goal to increase this number, independently of revenue), and (iv) a measure of compliance with prescribed number of presentations of specific offers (for example, an agreement may be in place indicating that specific offer will be presented at least 1,000 times a month a, or there may be a quota per department or product line).

One or more of the metrics are determined by one or more predictive model(s). Also, some of the metrics may be predetermined without execution of a predictive model. In one implementation, all the metrics are determined as expected values as a result of presenting the offer. For example, the cost is incurred by just presenting the offer. The revenue is measured as the likelihood of acceptance times the revenue if accepted, that is, it is the “expected” revenue just from the fact that the offer was presented. Along a similar line, the customer satisfaction may be measured after the offer is presented, independently of whether the offer was accepted or not. For instance, the “Increase in Customer Satisfaction” metric may be determined for each customer that is presented with an offer by having the customer answer a questionnaire which rates his/her level of satisfaction during such presentation.

In the illustrated embodiment, a value has been generated for each goal and each offer (or action). For example, a cost of $50 results from presentation of Offer A, while a cost of $40 results from presentation of Offer B. (The numbers in parenthesis are normalized values as further described below). The $50 and $40 goal metrics for Offers A and B, respectively, correspond to the goal of “Minimize Costs.” Likewise, the goal of “Increase Revenue” is associated with a value of $90 for Offer A and a value of $120 for Offer B. That is, presentation of Offer A has an expected increase in revenue of $90, while presentation of Offer has an expected increase in revenue of $120. The goal “Increase Customer Satisfaction” has a value of 70 for Offer A and a value of −10 for Offer B, where high positive values correspond to high levels of customer satisfaction and high negative number correspond to high levels of customer dissatisfaction. The goal “Reduce Customer Returns” has a value of 10% for Offer A and a value of 30% for Offer B. That is, if Offer A is presented, there is a 10% chance that the purchased item will be returned by the particular customer and if Offer B is presented, there is a 30% likelihood that the product will be returned. The prediction model may also provide metrics for an “Increase Awareness” goal and a “Likelihood of Acceptance” KPI. As shown, Offer A has a value of 20 for the “Increase Awareness” goal, while Offer B has a value of 5 for this same goal. This metric indicates how much the potential customer increases his/her awareness of the product being offered if the offer is to be presented to such customer. The last KPI “Likelihood of Acceptance” in this example corresponds to the probability that the particular offer will be accepted by the current potential customer. As shown, Offer A has a 27% probability and Offer B has a 15% probability of being accepted.

Since the goal or KPI metrics determined for each offer (or action) do not all have the same units, the metrics need to be normalized in order to weigh the metrics of each offer and then determine which offer best meets the plurality of goals. Accordingly, after the prediction model provides a plurality of metrics for each goal or KPI, the goal metrics are normalized so that their values can be weighed and compared to determine which action to perform. In the illustrated example, normalized values for each goal metric are shown in parenthesis next to each metric. After each metric is normalized, a total of each of the normalized goal metrics multiplied by a corresponding predetermined weight is then determined as illustrated in the last row of Table 500. The totals determined for each action are then compared to thereby determine a highest total. In the illustrated embodiment, the total for Offer A is the highest. The action that has the highest total (e.g., Offer A) is then selected from the plurality of possible actions and performed.

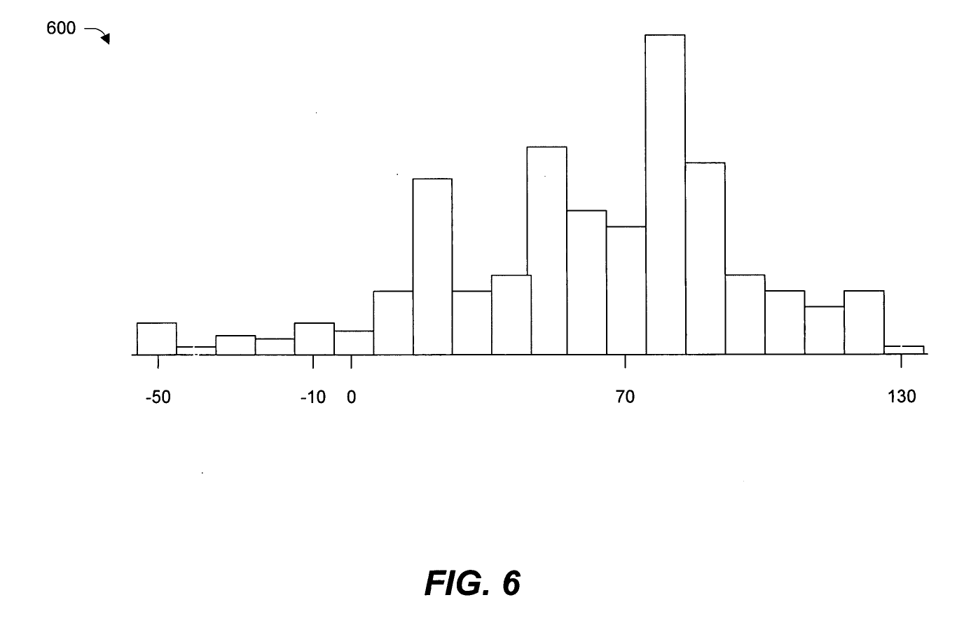

The goal or KPI metrics may be normalized in any suitable manner. FIG. 6 is a bar graph illustrating a normalization technique for a key performance indicator (KPI) or goal in accordance with a specific implementation of the present invention. In this example, the goal “Increase Customer Satisfaction” is illustrated. The bar graph shows the counts for a set of “Increase Customer Satisfaction” metric values between −50 and 130. The counts have been collected over time for a plurality of previous input conditions or a number of potential customers for which the predictive model has been executed and/or the potential customers have already accepted or declined the offer. The counts may be collected for a group of action types that have similar characteristics and the same set of goals. For example, counts may be collected for all offers for audio/video type products, and these offer types have the goals or KPI's illustrated in FIG. 5.

In one embodiment, each metric for the current potential customer (or set of current input conditions) is given a normalized value for each offer (or action). In a specific implementation, a point value is assigned for each goal metric of each action, and this point value corresponds to the percentage of counts for previously determined goal metric values that are worse than the current goal metric value. As shown in the bar graph of FIG. 6, the “Increase Customer Satisfaction” metric 70 for Offer A is better than 40% of the total counts (or 40% of the total counts are below 70). Thus, the “Increase Customer Satisfaction” for Offer A is assigned a normalized value of 40. Likewise, since the metric −10 for Offer B is better than 5% of the total counts, the “Increase Customer Satisfaction” metric for Offer B is assigned a normalized value of 5.

Of course, the scale for determining the normalized value may be reversed for metrics where a lower number is “better” or more desired than a higher number. For example, the “Reduce Customer Returns” metric 10% for Offer A has a higher normalized value than the corresponding metric 30% for Offer B. A simplified example is presented in FIG. 5, where each goal metric (except the Increase Customer Satisfaction metric of FIG. 6) has a value between 0 (or 0%) and 100 (or 100%) and the counts for each percentage value has an equal number of counts.

The above described optimization techniques allow the results of a predictive model to be assessed while taking into account a diverse set of goals which one may wish to achieve. Even when these goals are competing goals, a decision can be efficiently determined from the predictive results. Additionally, a decision can be reached even when the goal metrics have different units. The example of FIG. 5 illustrates the assessment of six goal metrics, where some of the goal metrics have different units and different weights and correspond to competing goals. In sum, metrics for a full set of desired goals can be considered and weighed in order to determine which action to take.

The present invention may employ various computer-implemented operations involving information stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms such as, producing, identifying, running, determining, comparing, executing, downloading, or detecting. It is sometimes convenient, principally for reasons of common usage, to refer to these electrical or magnetic signals as bits, values, elements, variables, characters, or the like. It should remembered, however, that all of these and similar terms are to be associated with the appropriate physical quantities and are merely convenient labels applied to these quantities.

The present invention also relates to a device, system or apparatus for performing the aforementioned operations. The system may be specially constructed for the required purposes, or it may be a general purpose computer selectively activated or configured by a computer program stored in the computer. The processes presented above are not inherently related to any particular computer or other computing apparatus. In particular, various general purpose computers may be used with programs written in accordance with the teachings herein, or, alternatively, it may be more convenient to construct a more specialized computer system to perform the required operations.

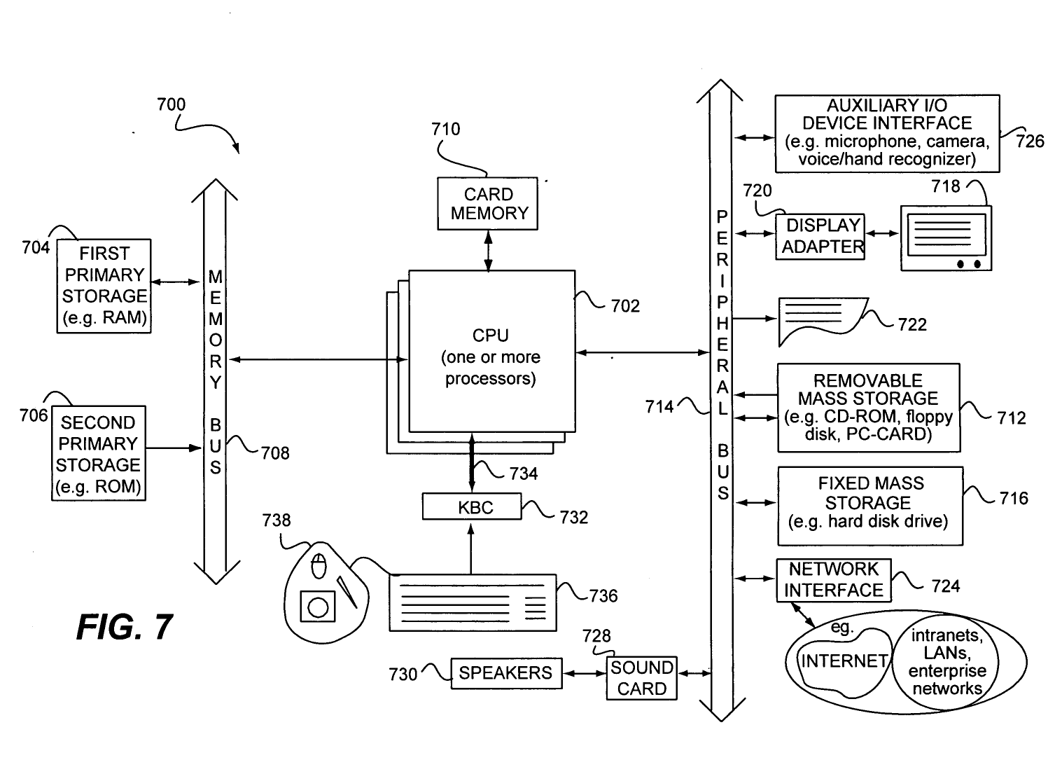

FIG. 7 is a block diagram of a general purpose computer system 700 suitable for carrying out the processing in accordance with one embodiment of the present invention. Other computer system architectures and configurations can be used for carrying out the processing of the present invention. Computer system 700, made up of various subsystems described below, includes at least one microprocessor subsystem (also referred to as a central processing unit, or CPU) 702. That is, CPU 702 can be implemented by a single-chip processor or by multiple processors. CPU 702 is a general purpose digital processor which controls the operation of the computer system 700. Using instructions retrieved from memory, the CPU 702 controls the reception and manipulation of input information, and the output and display of information on output devices.

CPU 702 is coupled bi-directionally with a first primary storage 704, typically a random access memory (RAM), and uni-directionally with a second primary storage area 706, typically a read-only memory (ROM), via a memory bus 708. As is well known in the art, primary storage 704 can be used as a general storage area and as scratch-pad memory, and can also be used to store input data and processed data. It can also store programming instructions and data, in addition to other data and instructions for processes operating on CPU 702, and is typically used for fast transfer of data and instructions bi-directionally over memory bus 708. Also, as is well known in the art, primary storage 706 typically includes basic operating instructions, program code, data and objects used by the CPU 702 to perform its functions. Primary storage devices 704 and 706 may include any suitable computer-readable storage media, described below, depending on whether, for example, data access needs to be bi-directional or uni-directional. CPU 702 can also directly and very rapidly retrieve and store frequently needed data in a cache memory 710.

A removable mass storage device 712 provides additional data storage capacity for the computer system 700, and is coupled either bi-directionally or uni-directionally to CPU 702 via a peripheral bus 714. For example, a specific removable mass storage device commonly known as a CD-ROM typically passes data uni-directionally to the CPU 702, whereas a floppy disk can pass data bi-directionally to the CPU 702. Storage 712 may also include computer-readable media such as magnetic tape, flash memory, signals embodied in a carrier wave, Smart Cards, portable mass storage devices, and other storage devices. A fixed mass storage 716 also provides additional data storage capacity and is coupled bi-directionally to CPU 702 via peripheral bus 714. Generally, access to these media is slower than access to primary storages 704 and 706. Mass storage 712 and 716 generally store additional programming instructions, data, and the like that typically are not in active use by the CPU 702. It will be appreciated that the information retained within mass storage 712 and 716 may be incorporated, if needed, in standard fashion as part of primary storage 704 (e.g. RAM) as virtual memory.

In addition to providing CPU 702 access to storage subsystems, the peripheral bus 714 is used to provide access to other subsystems and devices as well. In the described embodiment, these include a display monitor 718 and adapter 720, a printer device 722, a network interface 724, an auxiliary input/output device interface 726, a sound card 728 and speakers 730, and other subsystems as needed.

The network interface 724 allows CPU 702 to be coupled to another computer, computer network, or telecommunications network using a network connection as referred to. Through the network interface 724, it is contemplated that the CPU 702 might receive information, e.g., objects, program instructions, or bytecode instructions from a computer in another network, or might output information to a computer in another network in the course of performing the above-described method steps. Information, often represented as a sequence of instructions to be executed on a CPU, may be received from and outputted to another network, for example, in the form of a computer data signal embodied in a carrier wave. An interface card or similar device and appropriate software implemented by CPU 702 can be used to connect the computer system 700 to an external network and transfer data according to standard protocols. That is, method embodiments of the present invention may execute solely upon CPU 702, or may be performed across a network such as the Internet, intranet networks, or local area networks, in conjunction with a remote CPU that shares a portion of the processing. Additional mass storage devices (not shown) may also be connected to CPU 702 through network interface 724.

Auxiliary I/O device interface 726 represents general and customized interfaces that allow the CPU 702 to send and, more typically, receive data from other devices. Also coupled to the CPU 702 is a keyboard controller 732 via a local bus 734 for receiving input from a keyboard 736 or a pointer device 738, and sending decoded symbols from the keyboard 736 or pointer device 738 to the CPU 702. The pointer device may be a mouse, stylus, track ball, or tablet, and is useful for interacting with a graphical user interface.

In addition, embodiments of the present invention further relate to computer storage products with a computer readable medium that contain program code for performing various computer-implemented operations. The computer-readable medium is any data storage device that can store data which can thereafter be read by a computer system. Examples of computer-readable media include, but are not limited to, all the media mentioned above, including hard disks, floppy disks, and specially configured hardware devices such as application-specific integrated circuits (ASICs) or programmable logic devices (PLDs). The computer-readable medium can also be distributed as a data signal embodied in a carrier wave over a network of coupled computer systems so that the computer-readable code is stored and executed in a distributed fashion.

It will be appreciated by those skilled in the art that the above described hardware and software elements are of standard design and construction. Other computer systems suitable for use with the invention may include additional or fewer subsystems. In addition, memory bus 708, peripheral bus 714, and local bus 734 are illustrative of any interconnection scheme serving to link the subsystems. For example, a local bus could be used to connect the CPU to fixed mass storage 716 and display adapter 720. The computer system referred to in FIG. 7 is but an example of a computer system suitable for use with the invention. Other computer architectures having different configurations of subsystems may also be utilized.

Although the foregoing invention has been described in some detail for purposes of clarity of understanding, it will be apparent that certain changes and modifications may be practiced within the scope of the appended claims. For instance, the following claims often use the article “a” or “an” and use of such article does not limit the claim scope to a single element. Therefore, the described embodiments should be taken as illustrative and not restrictive, and the invention should not be limited to the details given herein but should be defined by the following claims and their full scope of equivalents.

1. A method of optimizing results produced by a predictive model in order to determine which action to perform out of a plurality of actions, the method comprising:
(a) for a plurality of possible actions, providing a plurality of goal metrics based on a plurality of input conditions, wherein one or more of the goal metrics are produced by one or more predictive models;
(b) normalizing the plurality of goal metrics;
(c) for each possible action, determining a total of each of the normalized goal metrics multiplied by a corresponding predetermined weight;
(d) comparing the totals determined for the plurality of possible actions to thereby determine a highest total; and
(e) performing an action selected from the plurality of possible actions, wherein the selected action has the highest total.

2. A method as recited in claim 1, wherein the plurality of possible actions are a plurality of offers which can be presented to a potential customer.

3. A method as recited in claim 2, wherein the offers can be presented in the form of one or more web pages to a customer who is currently accessing a web server.

4. A method as recited in claim 2, wherein the offers can be presented in the form of an automated Interactive Voice Recognition (IVR) option to a customer who is currently accessing a telephone call center.

5. A method as recited in claim 2, wherein the goal metrics include a minimum cost metric, an increase in revenue metric, an increase in customer satisfaction metric, and a likelihood of acceptance of offer metric.

6. A method as recited in claim 5, wherein the goal metrics further include any metric selected from a group consisting of a reduction of customer returns metric, an increase in awareness metric, a compliance metric for measuring the compliance level'with a marketing person's objective, a service level agreement metric measuring the compliance to an agreed upon service metric, a measure of the number of products owned by the customer, and a measure of compliance with prescribed number of presentations of specific offers.

7. A method as recited in claim 1, further comprising repeating operations (a) through (e) for a plurality of sets of input conditions, wherein normalizing the goal metrics for a current set of input conditions comprises assigning a point value for each goal metric of each action, wherein the point value corresponds to the percentage of previously determined corresponding goal metric values that are less valuable than the current goal metric value.

8. A method as recited in claim 7, wherein the sets of input conditions corresponding to a plurality of customer profiles of a plurality of customers and the possible actions are a plurality of offers which were presented to the customers.

9. A method as recited in claim 7, wherein at least two of the goal metrics have different units.

10. A method as recited in claim 7, wherein at least two of the goal metrics correspond to competing goals.

11. A computer system operable to optimize results produced by a predictive model in order to determine which action to perform out of a plurality of actions, the computer system comprising:
one or more processors;
one or more memory, wherein at least one of the processors and memory are adapted for:
(a) for a plurality of possible actions, providing a plurality of goal metrics based on a plurality of input conditions, wherein one or more of the goal metrics are produced by one or more predictive models;
(b) normalizing the plurality of goal metrics;
(c) for each possible action, determining a total of each of the normalized goal metrics multiplied by a corresponding predetermined weight;
(d) comparing the totals determined for the plurality of possible actions to thereby determine a highest total; and
(e) performing an action selected from the plurality of possible actions, wherein the selected action has the highest total.

12. A computer system as recited in claim 11, wherein the plurality of possible actions are a plurality of offers which can be presented to a potential customer.

13. A computer system as recited in claim 12, wherein the offers can be presented in the form of one or more web pages to a customer who is currently accessing a web server.

14. A computer system as recited in claim 12, wherein the offers can be presented in the form of an automated Interactive Voice Recognition (IVR) option to a customer who is currently accessing a telephone call center.

15. A computer system as recited in claim 12, wherein the goal metrics include a minimum cost metric, an increase in revenue metric, an increase in customer satisfaction metric, and a likelihood of acceptance of offer metric.

16. A computer system as recited in claim 15, wherein the goal metrics further include any metric selected from a group consisting of a reduction of customer returns metric, an increase in awareness metric, a compliance metric for measuring the compliance level with a marketing person's objective, a service level agreement metric measuring the compliance to an agreed upon service metric, a measure of the number of products owned by the customer, and a measure of compliance with prescribed number of presentations of specific offers.

17. A computer system as recited in claim 11, wherein the at least one of the processors and memory are further adapted for repeating operations (a) through (e) for a plurality of sets of input conditions, wherein normalizing the goal metrics for a current set of input conditions comprises assigning a point value for each goal metric of each action, wherein the point value corresponds to the percentage of previously determined corresponding goal metric values that are less valuable than the current goal metric value.

18. A computer system as recited in claim 17, wherein the sets of input conditions corresponding to a plurality of customer profiles of a plurality of customers and the possible actions are a plurality of offers which were presented to the customers.

19. A computer system as recited in claim 17, wherein at least two of the goal metrics have different units.

20. A computer system as recited in claim 17, wherein at least two of the goal metrics correspond to competing goals.

21. A computer program product for optimizing results produced by a predictive model in order to determine which action to perform out of a plurality of actions, the computer program product comprising:
at least one computer readable medium;
computer program instructions stored within the at least one computer readable product configured for:
(a) for a plurality of possible actions, providing a plurality of goal metrics based on a plurality of input conditions, wherein one or more of the goal metrics are produced by one or more predictive models;
(b) normalizing the plurality of goal metrics;
(c) for each possible action, determining a total of each of the normalized goal metrics multiplied by a corresponding predetermined weight;
(d) comparing the totals determined for the plurality of possible actions to thereby determine a highest total; and
(e) performing an action selected from the plurality of possible actions, wherein the selected action has the highest total.

22. A computer program product as recited in claim 21, wherein the plurality of possible actions are a plurality of offers which can be presented to a potential customer.

23. A computer program product as recited in claim 22, wherein the offers can be presented in the form of one or more web pages to a customer who is currently accessing a web server.

24. A computer program product as recited in claim 22, wherein the offers can be presented in the form of an automated Interactive Voice Recognition (IVR) option to a customer who is currently accessing a telephone call center.

25. A computer program product as recited in claim 22, wherein the goal metrics include a minimum cost metric, an increase in revenue metric, an increase in customer satisfaction metric, and a likelihood of acceptance of offer metric.

26. A computer program product as recited in claim 25, wherein the goal metrics further include any metric selected from a group consisting of a reduction of customer returns metric, an increase in awareness metric, a compliance metric for measuring the compliance level with a marketing person's objective, a service level agreement metric measuring the compliance to an agreed upon service metric, a measure of the number of products owned by the customer, and a measure of compliance with prescribed number of presentations of specific offers.

27. A computer program product as recited in claim 21, the computer program instructions stored within the at least one computer readable product further configured for repeating operations (a) through (e) for a plurality of sets of input conditions, wherein normalizing the goal metrics for a current set of input conditions comprises assigning a point value for each goal metric of each action, wherein the point value corresponds to the percentage of previously determined corresponding goal metric values that are less valuable than the current goal metric value.

28. A computer program product as recited in claim 27, wherein the sets of input conditions corresponding to a plurality of customer profiles of a plurality of customers and the possible actions are a plurality of offers which were presented to the customers.

29. A computer program product as recited in claim 27, wherein at least two of the goal metrics have different units.

30. A computer program product as recited in claim 27, wherein at least two of lo the goal metrics correspond to competing goals.

31. An apparatus for optimizing results produced by a predictive model in order to determine which action to perform out of a plurality of actions, comprising:
means for providing a plurality of goal metrics for a plurality of possible actions based on a plurality of input conditions, wherein one or more of the goal metrics are produced by one or more predictive models;
means for normalizing the plurality of goal metrics;
means for determining a total of each of the normalized goal metrics multiplied by a corresponding predetermined weight for each possible action;
means for comparing the totals determined for the plurality of possible actions to thereby determine a highest total; and
means for performing an action selected from the plurality of possible actions, wherein the selected action has the highest total.
